(19) United States
(12) Patent Application Publication
(10) Pub. No.: US 2010/0111137 A1
(43) Pub. Date: May 6, 2010

(54) TEMPERATURE SENSING CIRCUIT USING CMOS SWITCH-CAPACITOR

(76) Inventors: Chih-Chia Chen, Taipei City (TW); Li-Sheng Cheng, Yunlin County (TW)

Correspondence Address: NORTH AMERICA INTELLECTUAL PROPERTY CORPORATION, P.O. BOX 506, MERRIFIELD, VA, 22116, US

(21) Appl. No.: 12/350,244

(22) Filed: Jan. 8, 2009

(30) Foreign Application Priority Data
Oct. 31, 2008 (TW) 097141974

(51) Int. Cl. G01K 7/01

(52) U.S. Cl. 374/178; 374/E07.035

(57) ABSTRACT

A temperature sensing circuit using CMOS switch-capacitor includes a PNP BJT, a hysteresis comparator, a transconductance amplifier, two current sources, two capacitors, and six switches. A voltage complementary to the absolute temperature (CTAT) is generated according to the PNP BJT, and a voltage proportional to the absolute temperature (PTAT) is generated according to two capacitors and the transconductance amplifier. When the voltage proportional to absolute temperature is greater than the voltage complementary to absolute temperature as the temperature rising, the hysteresis comparator outputs a high level signal.

### BACKGROUND OF THE INVENTION

1. Field of the Invention

The present invention relates to a temperature sensing circuit, and more particularly, to a temperature sensing circuit using CMOS switch-capacitor.

2. Description of the Prior Art

In recent years, rapid developments in integrated circuit technology have reached the stage where a single-packaged chip may contain millions of transistors. As such, when an integrated circuit configured with a large number of transistors operates at a high clock rate, the amount of heat dissipated will be enormous to the extent that the operating temperature may exceed 100 degrees centigrade. Due to the change in temperature, all components in the chip will be adversely affected, since temperature and conductivity have an inversely proportional relationship. Therefore, when temperature rises, the electrical characteristics of components will change accordingly. The most evident effect is that operating speed and overall efficiency are reduced.

Please refer to FIG. 1. FIG. 1 is a schematic diagram of a conventional temperature sensing circuit. The temperature sensing circuit 10 includes a current mirror 11 and a Widlar current source 12. By matching transistors in the current mirror 11, the temperature sensing circuit 1 will have equal currents I1, I2, I3, i.e., I1=I2=I3. When the transistor Q2 of the Widlar current source 12 operates in the forward active region, the current 12 flowing through the transistor Q2 will be

$$I 2 = \frac{1}{R 1} {V}_{T} ln ( n ) \qquad EQU ( 1 )$$

wherein n is the emitter-base junction ratio between the transistor Q2 and the transistor Q1, and the thermal voltage V_{T}=26 mV*T/300° K. Since the voltage V_{TEMP}=I3*R2=I2*R2, the following equation can be obtained:

$${V}_{TEMP} = \frac{R 2}{R 1} {V}_{T} ln ( n ) \qquad EQU ( 2 )$$

Therefore, the amount of change in the voltage V_{TEMP} is determined by the values of n and R2/R1. For example, the emitter-base junction ratio between the transistor Q2 and the transistor Q1 is (n=4), the resistor R1=3.6K, R2=30K. By substituting these parameters into EQU (2), the following equation can be obtained:

$${V}_{TEMP} = 300 mV * \frac{T}{300 ° K} \qquad EQU ( 3 )$$

From EQU (3), when the temperature rises by 1.degree.K, the voltage V_{TEMP} rises by 1 mV. As such, when the temperature sensing circuit 7 is electrically connected to a main circuit (not shown) the operating temperature of the main circuit can be monitored by observing the voltage V_{TEMP} from the temperature sensing circuit 7 so that thermal protection of the main circuit can be activated when appropriate.

However, the foregoing analysis was made under ideal conditions in practice, due to manufacturing constraints, the actual output of the temperature sensing circuit 10 usually differs from the original design. It is noted that the accuracy of the voltage V_{TEMP} depends on the actual values of n and R2/R1. Therefore, during manufacturing, if a lower value of R2/R1 is desired, a higher value of n must be provided for compensation. For example, if R2/R1=2, the value of n must be as high as 320 to satisfy the condition that when the temperature rises by 1.degree.K, the voltage V_{TEMP} rises by 1 mV. Nevertheless, the value of n is determined by the physical characteristics of the transistors Q2 and Q1 and cannot be adjusted. If manufacture of the transistors Q2 and Q1 is based simply on the calculated values, the outcome will be a mismatch in the current gains 13 of the transistors Q2 and Q1, thereby resulting in failure of the temperature sensing circuit 10 to operate normally and inability of the temperature sensing circuit 10 to serve the purpose of temperature measuring. Thus, to ensure the accuracy of the characteristic curve of the circuit, a value smaller than 10 is usually adopted for n. This introduces another design problem since the value of R2/R1 must be correspondingly increased to satisfy the aforesaid requirement. However, in view of manufacturing constraints, it is known that the resistance values of resistors cannot be accurately controlled. Due to the requirement of a high resistance ratio R2/R1, the resultant error tends to be too high.

### SUMMARY OF THE INVENTION

According to an embodiment of the present invention, a temperature sensing circuit using CMOS switch-capacitor comprises a PNP bipolar junction transistor (BJT), a comparator, a amplifier, a first current source, a second current source, a first capacitor, a second capacitor, a first switch, a second switch, a third switch, a fourth switch, a fifth switch, and a sixth switch. The PNP bipolar junction transistor (BJT) has an emitter, a collector electrically connected to a ground, and a base electrically connected to the collector. The comparator has a positive input end, a negative input end, and an output end. The amplifier has an input end and an output end electrically connected to the positive input end of the comparator. The first current source is used for providing a first current. The second current source is used for providing a second current. The first capacitor has a first end electrically connected to the emitter of the PNP BJT, and a second end electrically connected to the input end of the amplifier. The second capacitor has a first end electrically connected to the input end of the amplifier, and a second end. The first switch has a first end electrically connected to the first current source, and a second end electrically connected to the emitter of the PNP BJT. The second switch has a first end electrically connected to the second current source, and a second end electrically connected to the emitter of the PNP BJT. The third switch has a first end electrically connected to the emitter of the PNP BJT, and a second end electrically connected to the negative input end of the comparator. The fourth switch has a first end electrically connected to the input end of the amplifier, and a second end electrically connected to the output end of the amplifier. The fifth switch has a first end electrically connected to the second end of the second capacitor, and a second end electrically connected to the output end of the amplifier. The sixth switch has a first end electrically connected to the second end of the second capacitor, and a second end electrically connected to the ground.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional temperature sensing circuit.

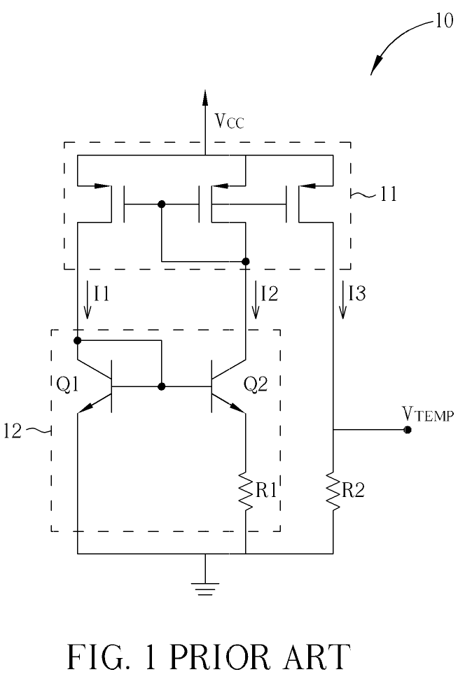

FIG. 2 is a circuitry of a temperature sensing circuit using CMOS switch-capacitor according to the present invention.

FIG. 3 is a schematic diagram of the temperature sensing circuit operating in the initial/sample duration according to the present invention.

FIG. 4 is a schematic diagram of the temperature sensing circuit operating in the hold/compare duration according to the present invention.

FIG. 5 is a graph of the voltage to the temperature of the temperature sensing circuit according to the present invention.

### DETAILED DESCRIPTION

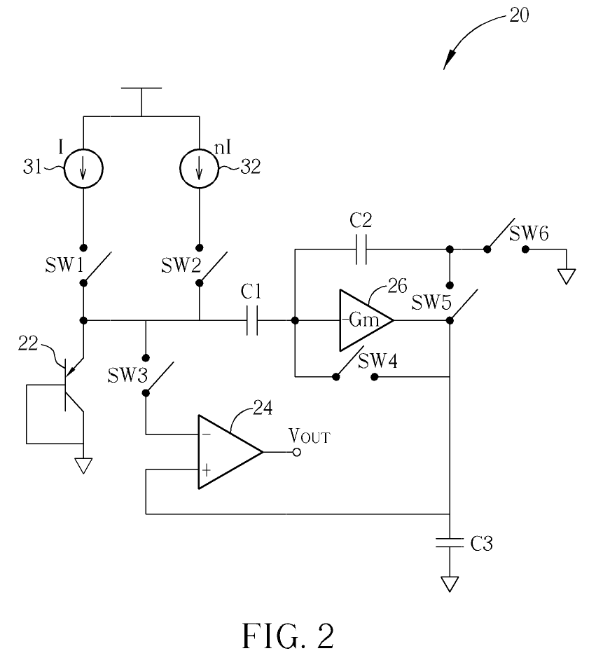

Please refer to FIG. 2. FIG. 2 is a circuitry of a temperature sensing circuit using CMOS switch-capacitor according to the present invention. The temperature sensing circuit 20 comprises a PNP bipolar junction transistor (BJT) 22, a hysteresis comparator 24, a transconductance amplifier 26, a first current source 31, a second current source 32, a first capacitor C1, a second capacitor C2, a third capacitor C3, a first switch SW1, a second switch SW2, a third switch SW3, a fourth switch SW4, a fifth switch SW5, and a sixth switch SW6. The base of the PNP BJT 22 is electrically connected to the collector of the PNP BJT 22, and the collector of the PNP BJT 22 is electrically connected to the ground. The negative input end of the hysteresis comparator 24 is electrically connected to the emitter of the PNP BJT 22 via the first switch SW1, and the positive input end of the hysteresis comparator 24 is electrically connected to the output end of the transconductance amplifier 26. The output end of the transconductance amplifier 26 is electrically connected to the input end of the transconductance amplifier 26 via the fourth switch SW4, and the input end of the transconductance amplifier 26 is electrically connected to the emitter of the PNP BJT 22 via the first capacitor C1. The first current source 31 is electrically connected to the emitter of the PNP BJT 22 via the first switch SW1. The second current source 32 is electrically connected to the emitter of the PNP BJT 22 via the second switch SW2. The first end of the second capacitor C2 is electrically connected to the input end of the transconductance amplifier 26, and the second of the second capacitor C2 is electrically connected to the input end of the transconductance amplifier 26 via fifth switch SW5. Besides, the second end of the second capacitor C2 is electrically connected to the ground via sixth switch SW6. The third capacitor C3 is electrically connected between the output end of the transconductance amplifier 26 and the ground. The first switch SW1, the third switch SW3, and the fifth switch SW5 are controlled by a first control signal. The second switch SW2, the fourth switch SW4, and the sixth switch SW6 are controlled by a second control signal. The first control signal and the second control signal are complementary control signals. The first current source 31 can provide the current I, and the second current source 32 can provide the current nI.

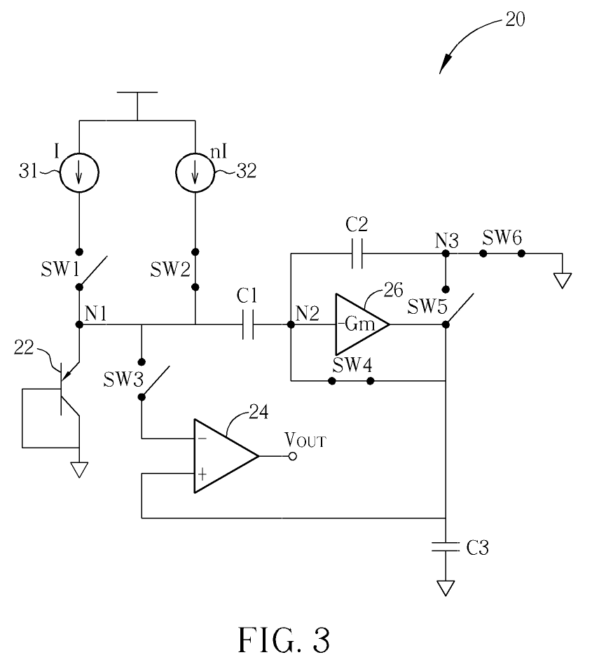

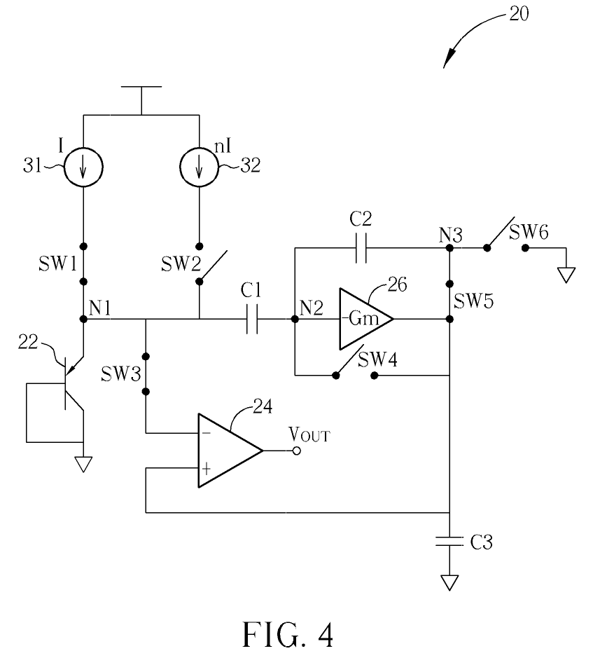

Please refer to FIG. 3 and FIG. 4. FIG. 3 is a schematic diagram of the temperature sensing circuit operating in the initial/sample duration according to the present invention. FIG. 4 is a schematic diagram of the temperature sensing circuit operating in the hold/compare duration according to the present invention. As shown in FIG. 3, when the temperature sensing circuit 20 operates in the initial/sample duration, the first switch SW1, the third switch SW3, and the fifth switch SW5 are turned off, and the second switch SW2, the fourth switch SW4, and the sixth switch SW6 are turned on. The second current source 32 provides the current nI to the node N1 via second switch SW2. Thus, the voltage at the emitter of the PNP BJT 22 can be represented as:

$${V}_{EB} = {V}_{T} ln \frac{nI}{{I}_{S}} \qquad EQU ( 4 )$$

As shown in FIG. 4, when the temperature sensing circuit 20 operates in the hold/compare duration, the first switch SW1, the third switch SW3, and the fifth switch SW5 are turned on, and the second switch SW2, the fourth switch SW4, and the sixth switch SW6 are turned off. The first current source 31 provides the current I to the node N1 via first switch SW1. Thus, the voltage at the emitter of the PNP BJT 22 can be represented as:

$${V}_{EB} = {V}_{T} ln \frac{I}{{I}_{S}} \qquad EQU ( 5 )$$

After the initial/sample duration and the hold/compare duration, the electric charge Q1 stored in the first capacitor C1 and the electric charge Q2 stored in the second capacitor C2 can be represented respectively as:

Q1=C1*V_{T ln}(n) EQU (6)

Q2=C2*Vg EQU (7)

The voltage at the node N1 decreases, so that the electric charge Q1 flows from the node N2 to the node N1. When the voltage at the node N2 decreases, the electric charge Q2 flows from the node N3 to the node N2. The node N2 and the node N3 form a feedback loop by the transconductance amplifier 26, so the electric charge Q1 and the electric charge Q2 will achieve the balance in the end; that is, Q1=Q2. Thus, the output voltage Vg of the transconductance amplifier 26 can be represented as:

$$Vg = \frac{C 1}{C 2} {V}_{T} ln ( n ) \qquad EQU ( 8 )$$

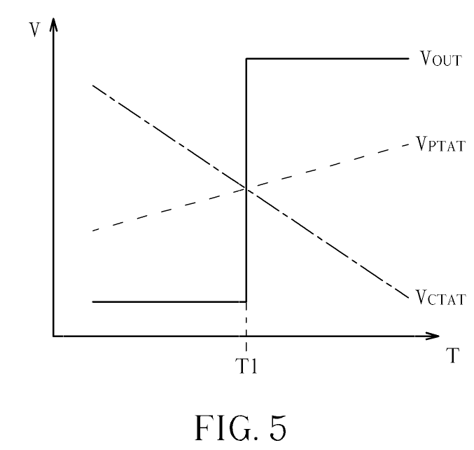

Please refer to FIG. 5. FIG. 5 is a graph of the voltage to the temperature of the temperature sensing circuit according to the present invention. In FIG. 5, the vertical coordinates represent the voltage, and the horizontal coordinates represent the temperature. V_{CTAT} represents the voltage at the emitter of the PNP BJT 22. V_{PTAT} represents the output voltage of the transconductance amplifier 26. Vout represents the output voltage of the temperature sensing circuit 20. From EQU (4), the voltage V_{EB} of the emitter of the PNP BJT 22 is complementary to absolute temperature (CTAT), which is represented as V_{CTAT}. From EQU (8), the output voltage Vg of the transconductance amplifier 26 is proportional to absolute temperature (PTAT), which is represented as V_{PTAT}. When the temperature increases, the voltage V_{CTAT} will decrease and the voltage V_{CTAT} will increase. The voltage V_{CTAT} and the voltage V_{CTAT} intersect at the temperature T1 in the horizontal coordinates. The T1 value can be adjusted according to the capacitance ratio C1/C2 of the first capacitor C1 and the second capacitor C2. In the present semiconductor process, the capacitance can be controlled in a smaller error than the resistance. Thus, the temperature sensing circuit 20 outputs the low voltage level when the temperature is smaller than T1; the temperature sensing circuit 20 outputs the high voltage level when the temperature is greater than T1. In addition, the hysteresis comparator 24 can prevent the output voltage of the sensing circuit from oscillating between the low voltage level and the high voltage level.

In conclusion, the temperature sensing circuit using CMOS switch-capacitor according to the present invention comprises a PNP BJT, a hysteresis comparator, a transconductance amplifier, two current sources, two capacitors, and six switches. The first switch, the third switch, and the fifth switch are controlled by a first control signal. The second switch, the fourth switch, and the sixth switch are controlled by a second control signal. The first control signal and the second control signal are complementary control signals. A voltage complementary to the absolute temperature (CTAT) is generated according to the PNP BJT, and a voltage proportional to the absolute temperature (PTAT) is generated according to two capacitors and the transconductance amplifier. After the temperature sensing circuit completes the initial/sample duration and the hold/compare duration by controlling the switches, the voltage complementary to absolute temperature is transmitted to the negative input end of the hysteresis comparator, and the voltage proportional to absolute temperature is transmitted to the positive input end of the hysteresis comparator. Thus, when the voltage proportional to absolute temperature is greater than the voltage complementary to absolute temperature as the temperature increasing, the hysteresis comparator outputs a high level signal. The temperature sensing circuit of the present invention uses the capacitance ratio of the first capacitor and the second capacitor to determine the sense temperature value so as to increase the accuracy.

Those skilled in the art will readily observe that numerous modifications and alterations of the device and method may be made while retaining the teachings of the invention.

What is claimed is:

1. A temperature sensing circuit using CMOS switch-capacitor, comprising:
a PNP bipolar junction transistor (BJT), having a emitter, a collector electrically connected to a ground, and a base electrically connected to the collector;
a comparator, having a positive input end, a negative input end, and an output end;
an amplifier, having an input end and an output end electrically connected to the positive input end of the comparator;
a first current source, for providing a first current;
a second current source, for providing a second current;
a first capacitor, having a first end electrically connected to the emitter of the PNP BJT, and a second end electrically connected to the input end of the amplifier;
a second capacitor, having a first end electrically connected to the input end of the amplifier, and a second end;
a first switch, having a first end electrically connected to the first current source, and a second end electrically connected to the emitter of the PNP BJT;
a second switch, having a first end electrically connected to the second current source, and a second end electrically connected to the emitter of the PNP BJT;
a third switch, having a first end electrically connected to the emitter of the PNP BJT, and a second end electrically connected to the negative input end of the comparator;
a fourth switch, having a first end electrically connected to the input end of the amplifier, and a second end electrically connected to the output end of the amplifier;
a fifth switch, having a first end electrically connected to the second end of the second capacitor, and a second end electrically connected to the output end of the amplifier; and
a sixth switch, having a first end electrically connected to the second end of the second capacitor, and a second end electrically connected to the ground.

2. The temperature sensing circuit of claim 1, further comprising:
a third capacitor, having a first end electrically connected to the output end of the amplifier, and a second end electrically connected to the ground.

3. The temperature sensing circuit of claim 1, wherein the first switch, the third switch, and the fifth switch are controlled by a first control signal; the second switch, the fourth switch, and the sixth switch are controlled by a second control signal.

4. The temperature sensing circuit of claim 3, wherein the first control signal and the second control signal are complementary control signals.

5. The temperature sensing circuit of claim 1, wherein the second current is n times greater than the first current.

6. The temperature sensing circuit of claim 1, wherein the comparator is a hysteresis comparator.

7. The temperature sensing circuit of claim 1, wherein the amplifier is a transconductance amplifier.

8. The temperature sensing circuit of claim 1, wherein the PNP BJT is used to generate a voltage complementary to the absolute temperature.

9. The temperature sensing circuit of claim 1, wherein the first capacitor, the second capacitor, and the amplifier are used to generate a voltage proportional to the absolute temperature.
